(19) United States
(12) Patent Application Publication
(10) Pub. No.: US 2002/0191671 A1
(43) Pub. Date: Dec. 19, 2002

(54) METHOD FOR THERMAL ANALYSIS OF A CLUTCH-BRAKE SYSTEM

(76) Inventors: Wayne M. Ferrell, Peoria, IL (US); Ganesh R. Iyer, Peoria, IL (US); Ramesh Sugavanam, Naperville, IL (US)

Correspondence Address: CATERPILLAR INC., 100 N.E. ADAMS STREET, PATENT DEPT., PEORIA, IL, 616296490

(21) Appl. No.: 09/829,653

(22) Filed: Apr. 10, 2001

(51) Int. Cl. G01K 1/14; G01K 13/00; G01N 25/00; G01K 3/00

(52) U.S. Cl. 374/141; 374/137; 374/45; 702/130

(57) ABSTRACT

A method for providing a thermal analysis of an assembly having a first component with an attached friction material controllably engaged with a second component. The method includes the steps of determining an initial interface temperature of the first and second components, determining a heat flux split as a function of the initial interface temperature, determining a first net heat flux into the first component and a second net heat flux into the second component as a function of the heat flux split, and determining a first and a second real interface temperature of the respective first and second components as a function of the respective first and second net heat fluxes.

### TECHNICAL FIELD

This invention relates generally to a method for providing a thermal analysis of a clutch-brake system having friction discs controllably engaged with separator plates and, more particularly, to a method for providing a thermal analysis of a clutch-brake system based on calculated net heat fluxes into each of the friction discs and separator plates.

### BACKGROUND

Clutches and brakes are commonly used to perform desired functions, such as engaging drive components of a mobile machine or stopping the movement of the mobile machine. The clutches and brakes, for example multiple-disc, oil-cooled clutch-brake systems, operate by controllably engaging friction disc components with corresponding separator plate components. The result of this engagement, caused by friction, is the development of large amounts of heat. It is required to remove this heat from the clutch-brake system as the heat is being generated to extend the useful life of the components and to prevent damage to the system.

The heat is removed by two methods. First, some of the heat is removed by conduction through the materials in the clutch-brake system. Second, some of the heat is carried away by convection; that is, the heat is dissipated by the oil and carried out of the clutch-brake system.

It has long been desired to know how much heat is generated and subsequently removed during operation of the clutch or brake. This information may then be used to design improvements which allow the clutch-brake system to operate cooler and more efficiently. However, it has often been difficult, if not impossible, to determine the proportions in which the generated heat is split between the friction discs, the separator plates, and the cooling oil. Knowledge of these proportions, i.e., heat flux split, are desired so that design considerations can be applied where needed the most. Traditional methods for determining the heat flux split have been based on simplifying assumptions, which have not matched test data very well.

The present invention is directed to overcoming one or more of the problems as set forth above.

### SUMMARY OF THE INVENTION

In one aspect of the present invention a method for providing a thermal analysis of an assembly having a first component with an attached friction material controllably engaged with a second component is disclosed. The method includes the steps of determining an initial interface temperature of the first and second components, determining a heat flux split as a function of the initial interface temperature, determining a first net heat flux into the first component and a second net heat flux into the second component as a function of the heat flux split, and determining a first and a second real interface temperature of the respective first and second components as a function of the respective first and second net heat fluxes.

### BRIEF DESCRIPTION OF THE DRAWINGS

FIG. 1 is a diagrammatic illustration of a clutch-brake system;

FIG. 2 is a diagrammatic illustration of a portion of the clutch-brake system of FIG. 1; and

FIG. 3 is a flow diagram illustrating a preferred method of the present invention.

### DETAILED DESCRIPTION

Referring to the drawings, a method for providing a thermal analysis of a clutch-brake system 102 is disclosed. The referral to a clutch-brake system refers to any of several types of friction engaging systems, including, but not limited to, clutches and brakes.

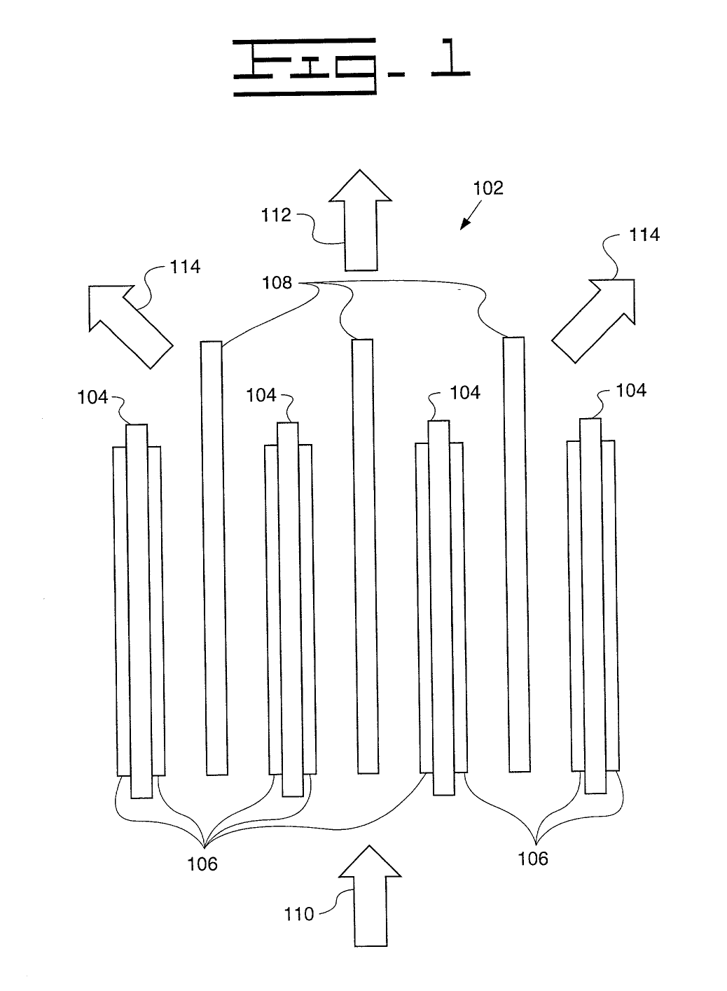

FIG. 1 diagrammatically illustrates a clutch-brake system 102 having a plurality of components, most notably a disc core 104, a friction material 106 bonded to the disc core 104, and a separator plate 108. The embodiment of FIG. 1 includes at least four sets of disc cores 104 with friction material 106, and separator plates 108. It is noted, however, that any number of these sets of components may be used in a typical clutch-brake system. For example, a brake may have only one set of components, i.e., one disc core 104 with friction material 106, and one separator plate 108. Alternatively, a brake designed for heavier duty applications may have more sets of components operating together.

In the preferred embodiment, each disc core 104 with friction material 106 is adapted to be controllably engaged with a corresponding separator plate 108. The engagement of the friction material 106 with a separator plate 108 allows for a desired work function to be performed. For example, in a clutch, the engagement of the friction material 106 with separator plates 108 controllably engages drive components of a mobile machine. In like manner, in a brake, the engagement of the friction material 106 with separator plates 108 controllably slows down or stops a machine, such as a mobile machine.

Preferably, the clutch-brake system 102 embodied in FIG. 1 is an oil-cooled system, having a coolant inlet flow 110 and a coolant outlet flow 112. The coolant inlet flow 110 allows cooled oil to enter the clutch-brake system 102, and the coolant outlet flow 112 removes heat from the clutch-brake system 102.

In addition to heat being removed from the clutch-brake system 102 by the coolant outlet flow 112, i.e., by convection, heat is also removed by conduction heat flow 114 through the components themselves.

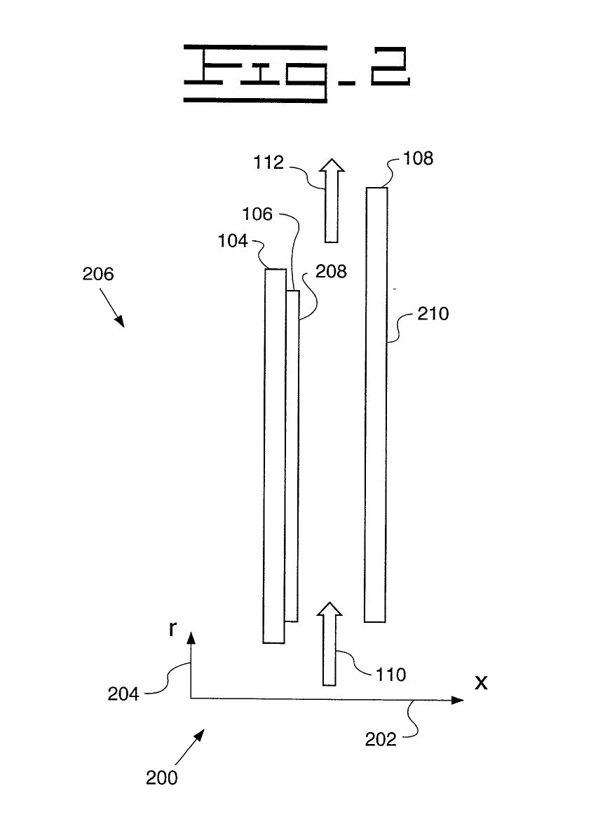

FIG. 2 is a diagrammatic illustration of an enlarged view of one set of components of FIG. 1. FIG. 2 depicts a disc core 104, a friction material 106 bonded to the disc core 104, and a separator plate 108. As described above, the friction material 106 is adapted to controllably engage the separator plate 108. Oil flow, including coolant inlet flow 110 and coolant outlet flow 112, is also shown. Furthermore, the components are displayed relative to a coordinate system 200, having an axial coordinate axis, x, and a radial coordinate axis, r. The radial coordinate axis r preferably originates at an inner diameter of the clutch-brake system 102 and extends toward an outer diameter of the clutch-brake system 102. It is noted that the direction of oil flow may be reversed so that the coolant inlet flow 110 flows from the top of the illustration of FIG. 2 and the coolant outlet flow flows out the bottom of the illustration of FIG. 2, so that oil flow is in a direction opposed to the radial coordinate axis r. More specifically, oil flow may flow from the outer diameter to the inner diameter of the clutch-brake system 102, rather than from the inner diameter to the outer diameter as FIG. 2 depicts.

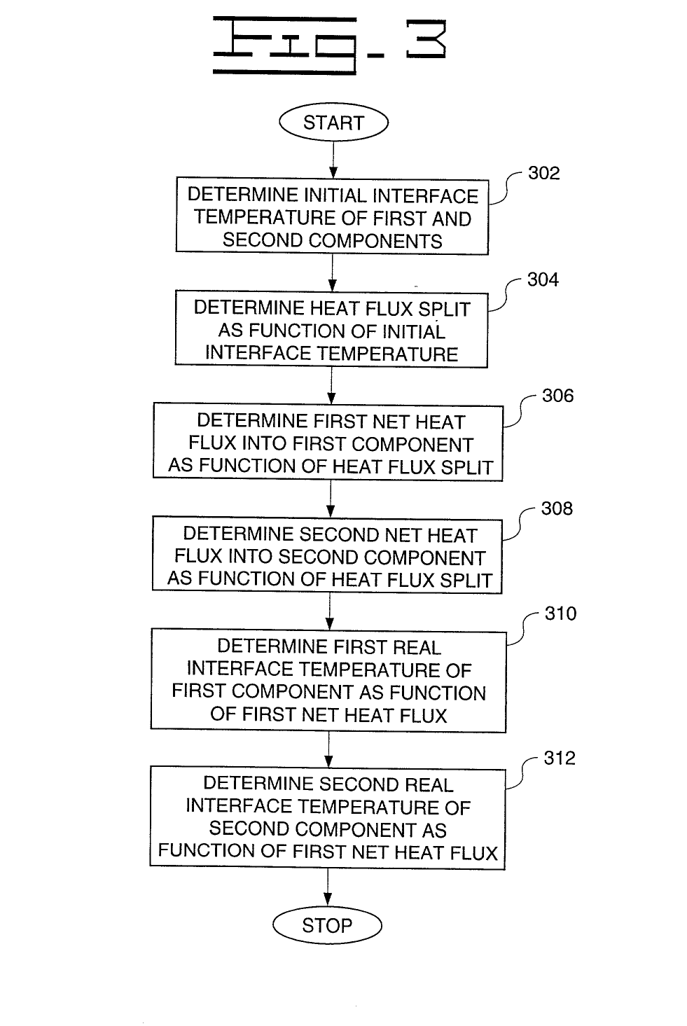

Referring to FIG. 3, and with continued reference to FIGS. 1 and 2, a flow diagram illustrating a preferred method of the present invention is shown. The flow diagram of FIG. 3 illustrates a method for providing a thermal analysis of an assembly 206 having a first component 208 with an attached friction material controllably engaged with a second component 210. In the preferred embodiment, the assembly 206 is a clutch-brake system 102, the first component 208 is a disc core with a friction material 106 bonded to the disc core 104, and the second component 210 is a separator plate 108. However, it is noted that the present invention is suited for other types of assemblies having a first component with an attached friction material controllably engaged with a second component as well, and is therefore not limited to just clutch-brake systems.

In a first control block 302, an initial interface temperature, i.e., a pseudo interface temperature, of the first and second components 208,210 is determined. Preferably, the initial interface temperature is calculated. For example, a technique suitable for calculating the initial interface temperature involves the use of explicit finite difference formulations, whereby the domain of the first and second components 208,210 are defined as a grid having grid points, i.e., nodes. This technique is useful because the interface temperature differs along various portions of the first and second components 208,210, and also differs at any instant of time. The use of techniques such as this are well known in the art.

An exemplary equation for calculating the initial interface temperature is:

$$\frac{q}{d a} = {k}_{2} \frac{ⅆ {T}_{2}}{ⅆ {x}_{2}} + {k}_{3} \frac{ⅆ {T}_{3}}{ⅆ {x}_{3}} \qquad ( Eq . 1 )$$

where q is an input power based on a torque and speed applied to the assembly 206, da is an elemental surface area of the first/second components 208,210, k₂ is a thermal conductivity of the first component 208, k₃ is a thermal conductivity of the second component 210, dT₂ is a temperature difference between the initial interface temperature and a temperature of a node within the first component 208, dT₃ is a temperature difference between the initial interface temperature and a temperature of a node within the second component 210, dx₂ is a step size of the first component 208, and dx₃ is a step size of the second component 210. The step sizes of the first and second components 208,210 are defined as distances between two nodes of the respective first and second components 208,210.

In a second control block 304, a heat flux split γ is determined as a function of the initial interface temperature. In the embodiment shown in FIG. 1, the heat flux split γ is useful in allowing determination of the proportions in which the generated heat is split between the separator plate 108, the friction material 106, and the coolant outlet flow 112.

In the preferred embodiment, the heat flux split γ is calculated by the equation:

$$γ = \frac{{k}_{2} \frac{ⅆ {T}_{2}}{ⅆ {x}_{2}}}{{k}_{3} \frac{ⅆ {T}_{3}}{ⅆ {x}_{3}}} . \qquad ( Eq . 2 )$$

In a third control block 306, a first net heat flux into the first component 208 is determined as a function of the heat flux split. In like manner, in a fourth control block 308, a second net heat flux into the second component 210 is determined as a function of the heat flux split.

In the preferred embodiment, the first net heat flux is calculated, preferably by use of the equation:

$${q}_{1} = \frac{q γ}{d a ( γ + 1 )} - {h}_{1} ⅆ {T}_{d} \qquad ( Eq . 3 )$$

where q₁ is the net heat flux into the first component 208, h₁ is a heat transfer coefficient for the first component 208, and dT_{d} is a temperature difference between a temperature of a cooling oil in the assembly 206 and a real interface temperature of the first component 208.

In the preferred embodiment, the second net heat flux is calculated, preferably by use of the equation:

$${q}_{2} = \frac{q}{d a ( γ + 1 )} - {h}_{2} ⅆ {T}_{p} \qquad ( Eq . 4 )$$

where q₂ is the net heat flux into the second component 210, h₂ is a heat transfer coefficient for the second component 210, and dTₚ is a temperature difference between a temperature of a cooling oil in the assembly 206 and a real interface temperature of the second component 210.

In a fifth control block 310 and a sixth control block 312, the first and second real interface temperatures of the respective first and second components 208,210 are determined as a function of the respective first and second net heat fluxes q₁ and q₂. Preferably, the first and second real interface temperatures are calculated by techniques that are well known in the art, given the net heat fluxes of the components and other physical characteristics of the components.

### Industrial Applicability

As an example of an application of the present invention, clutch-brake systems having friction discs controllably being engaged with separator plates generate large amounts of heat, which must be dissipated by either convection, conduction, or a combination of convection and conduction. It is constantly desired to design improvements in clutch-brake systems for more efficient and reliable operation, and to design improved techniques for cooling clutch-brake systems.

The present invention provides a method to predict temperatures within a clutch-brake system that closely track measured data, thus providing a method for thermally analyzing a clutch-brake system under various operating conditions.

Other aspects, objects, and features of the present invention can be obtained from a study of the drawings, the disclosure, and the appended claims.

What is claimed is:

1. A method for providing a thermal analysis of an assembly having a first component with an attached friction material controllably engaged with a second component, including the steps of:
determining an initial interface temperature of the first and second components as a function of a set of properties of the first and second components;
determining a heat flux split as a function of the initial interface temperature;
determining a first net heat flux into the first component and a second net heat flux into the second component as a function of the heat flux split; and
determining a first and a second real interface temperature of the respective first and second components as a function of the respective first and second net heat fluxes.

2. A method, as set forth in claim 1, wherein the assembly includes a clutch-brake system.

3. A method, as set forth in claim 2, wherein the clutch-brake system is an oil-cooled system, and wherein the first component includes a plurality of disc cores having friction material bonded thereto, and the second component includes a plurality of separator plates.

4. A method, as set forth in claim 1, wherein determining an initial interface temperature of the first and second components includes the step of calculating an initial interface temperature.

5. A method, as set forth in claim 4, wherein calculating an initial interface temperature includes the step of calculating the initial interface temperature using the equation:
$$\frac{q}{d a} = {k}_{2} \frac{ⅆ {T}_{2}}{ⅆ {x}_{2}} + {k}_{3} \frac{ⅆ {T}_{3}}{ⅆ {x}_{3}} ;$$
where q is an input power based on a torque and speed applied to the assembly, da is an elemental surface area of the first/second components, k₂ is a thermal conductivity of the first component, k₃ is a thermal conductivity of the second component, dT₂ is a temperature difference between the initial interface temperature and a temperature of a node within the first component, dT₃ is a temperature difference between the initial interface temperature and a temperature of a node within the second component, dx₂ is a step size of the first component, and dx₃ is a step size of the second component.

6. A method, as set forth in claim 1, wherein determining a heat flux split includes the step of calculating a heat flux split.

7. A method, as set forth in claim 6, wherein calculating a heat flux split includes the step of calculating a heat flux split using the equation:
$$γ = \frac{{k}_{2} \frac{ⅆ {T}_{2}}{ⅆ {x}_{2}}}{{k}_{3} \frac{ⅆ {T}_{3}}{ⅆ {x}_{3}}} ;$$
where γ is the heat flux split, k₂ is a thermal conductivity of the first component, k₃ is a thermal conductivity of the second component, dT₂ is a temperature difference between the initial interface temperature and a temperature of a node within the first component, dT₃ is a temperature difference between the initial interface temperature and a temperature of a node within the second component, dx₂ is a step size of the first component, and dx₃ is a step size of the second component.

8. A method, as set forth in claim 1, wherein determining a first net heat flux into the first component includes the step of calculating a first net heat flux into the first component.

9. A method, as set forth in claim 8, wherein calculating a first net heat flux into the first component includes the step of calculating a first net heat flux into the first component using the equation:
$${q}_{1} = \frac{q γ}{d a ( γ + 1 )} - {h}_{1} ⅆ {T}_{d} ;$$
where q₁ is the net heat flux into the first component, q is an input power based on a torque and speed applied to the assembly, γ is the heat flux split, da is an elemental surface area of at least one of the first and second components, h₁ is a heat transfer coefficient for the first component, and dT_{d} is a temperature difference between a temperature of a cooling oil in the assembly and a real interface temperature of the first component.

10. A method, as set forth in claim 1, wherein determining a second net heat flux into the second component includes the step of calculating a second net heat flux into the second component.

11. A method, as set forth in claim 10, wherein calculating a second net heat flux into the second component includes the step of calculating a second net heat flux into the second component using the equation:
$${q}_{2} = \frac{q}{d a ( γ + 1 )} - {h}_{2} ⅆ {T}_{p} ;$$
where q₂ is the net heat flux into the second component, q is an input power based on a torque and speed applied to the assembly, γ is the heat flux split, da is an elemental surface area of at least one of the first and second components, h₂ is a heat transfer coefficient for the second component, and dTₚ is a temperature difference between a temperature of a cooling oil in the assembly and a real interface temperature of the second component.

12. A method, as set forth in claim 1, wherein determining a first and a second real interface temperature of the respective first and second components includes the step of calculating a first and a second real interface temperature of the respective first and second components.

13. A method for providing a thermal analysis of an assembly having a first component with an attached friction material controllably engaged with a second component, including the steps of:
determining an initial interface temperature of the first and second components as a function of a set of properties of the first and second components;
determining a heat flux split as a function of the initial interface temperature;
calculating a first net heat flux into the first component and a second net heat flux into the second component as a function of the heat flux split using the equations:
$${q}_{1} = \frac{q γ}{d a ( γ + 1 )} - {h}_{1} ⅆ {T}_{d} , and {q}_{2} = \frac{q}{d a ( γ + 1 )} - {h}_{2} ⅆ {T}_{p} , respectively ;$$
where q₁ and q₂ are the net heat fluxes into the respective first and second components, q is an input power based on a torque and speed applied to the assembly, γ is the heat flux split, da is an elemental surface area of at least one of the first and second components, h₁ and h₂ are heat transfer coefficients for the respective first and second components, and dT_{d} and dTₚ are temperature differences between a temperature of a cooling oil in the assembly and a real interface temperature of the respective first and second components; and
determining a first and second real interface temperature of the respective first and second components as a function of the respective first and second net heat fluxes.

14. A method, as set forth in claim 13, wherein determining an initial interface temperature of the first and second components includes the step of calculating an initial interface temperature using the equation:
$$\frac{q}{d a} = {k}_{2} \frac{ⅆ {T}_{2}}{ⅆ {x}_{2}} + {k}_{3} \frac{ⅆ {T}_{3}}{ⅆ {x}_{3}} ;$$
where q is an input power based on a torque and speed applied to the assembly, da is an elemental surface area of at least one of the first and second components, k₂ is a thermal conductivity of the first component, k₃ is a thermal conductivity of the second component, dT₂ is a temperature difference between the initial interface temperature and a temperature of a node within the first component, dT₃ is a temperature difference between the initial interface temperature and a temperature of a node within the second component, dx₂ is a step size of the first component, and dx₃ is a step size of the second component.

15. A method, as set forth in claim 13, wherein determining a heat flux split includes the step of calculating a heat flux split using the equation:
$$γ = \frac{{k}_{2} \frac{ⅆ {T}_{2}}{ⅆ {x}_{2}}}{{k}_{3} \frac{ⅆ {T}_{3}}{ⅆ {x}_{3}}} ;$$
where γ is the heat flux split, k₂ is a thermal conductivity of the first component, k₃ is a thermal conductivity of the second component, dT₂ is a temperature difference between the initial interface temperature and a temperature of a node within the first component, dT₃ is a temperature difference between the initial interface temperature and a temperature of a node within the second component, dx₂ is a step size of the first component, and dx₃ is a step size of the second component.

16. A method for providing a thermal analysis of a clutch-brake system having at least one friction disc component controllably engaged with at least one corresponding separator plate component, including the steps of:
calculating an initial interface temperature of the friction disc and separator plate components as a function of a set of properties of the friction disc and separator plate components;
calculating a heat flux split as a function of the initial interface temperature;
calculating a first and a second net heat flux into the respective friction disc and separator plate components as a function of the heat flux split; and
calculating a first and a second real interface temperature of the respective friction disc and separator plate components as a function of the respective first and second net heat fluxes.

17. A method, as set forth in claim 16, wherein the clutch-brake system is an oil-cooled system.

18. A method, as set forth in claim 17, wherein the at least one friction disc component includes a plurality of disc cores having friction material bonded thereto, and wherein the at least one separator plate component includes a plurality of separator plates, and wherein each friction disc component is controllably engaged with a corresponding one of the separator plates.

19. A method, as set forth in claim 16, wherein calculating an initial interface temperature includes the step of calculating the initial interface temperature using the equation:
$$\frac{q}{d a} = {k}_{2} \frac{ⅆ {T}_{2}}{ⅆ {x}_{2}} + {k}_{3} \frac{ⅆ {T}_{3}}{ⅆ {x}_{3}} ;$$
where q is an input power based on a torque and speed applied to the clutch-brake system, da is a an elemental surface area of at least one of the friction disc and separator plate components, k₂ is a thermal conductivity of the friction disc component, k₃ is a thermal conductivity of the separator plate component, dT₂ is a temperature difference between the initial interface temperature and a temperature of a node within the friction disc component, dT₃ is a temperature difference between the initial interface temperature and a temperature of a node within the separator plate component, dx₂ is a step size of the friction disc component, and dx₃ is a step size of the separator plate component.

20. A method, as set forth in claim 16, wherein calculating a heat flux split includes the step of calculating a heat flux split using the equation:
$$γ = \frac{{k}_{2} \frac{ⅆ {T}_{2}}{ⅆ {x}_{2}}}{{k}_{3} \frac{ⅆ {T}_{3}}{ⅆ {x}_{3}}} ;$$
where γ is the heat flux split, k₂ is a thermal conductivity of the friction disc component, k₃ is a thermal conductivity of the separator plate component, dT₂ is a temperature difference between the initial interface temperature and a temperature of a node within the friction disc component, dT₃ is a temperature difference between the initial interface temperature and a temperature of a node within the separator plate component, dx₂ is a step size of the friction disc component, and dx₃ is a step size of the separator plate component.

21. A method, as set forth in claim 16, wherein calculating a first and a second net heat flux into the respective friction disc and separator plate components includes the step of calculating a first and a second net heat flux into the respective friction disc and separator plate components using the equations:
$${q}_{i} = \frac{q γ}{d a ( γ + 1 )} - {h}_{1} d {T}_{d} , and {q}_{2} = \frac{q}{d a ( γ + 1 )} - {h}_{2} d {T}_{p} , respectively ;$$
where q₁ and q₂ are the net heat fluxes into the respective friction disc and separator plate components, q is an input power based on a torque and speed applied to the clutch-brake system, γ is the heat flux split, da is an elemental surface area of at least one of the friction disc and separator plate components, h₁ and h₂ are heat transfer coefficients for the respective friction disc and separator plate components, and dT_{d} and dTₚ are temperature differences between a temperature of a cooling oil in the clutch-brake system and a real interface temperature of the respective friction disc and separator plate components.
